(19) United States
(12) Patent Application Publication
(10) Pub. No.: US 2007/0291322 A1
(43) Pub. Date: Dec. 20, 2007

(54) Communication Apparatus, Method For Controlling Communication Apparatus, Control Program, And Recording Medium

(76) Inventor: Hiroaki Hanafusa, Nara-shi (JP)

Correspondence Address: BIRCH STEWART KOLASCH & BIRCH, PO BOX 747, FALLS CHURCH, VA, 22040-0747, US

(21) Appl. No.: 11/663,262

(22) PCT Filed: Sep. 13, 2005
(86) PCT No.: PCT/JP05/16840

§ 371 Date: Mar. 20, 2007

(30) Foreign Application Priority Data
Sep. 22, 2004 (JP) 2004-275818

(51) Int. Cl. H04N 1/00

(52) U.S. Cl. 358/402

(57) ABSTRACT

A multifunction device (communication apparatus) (100) includes (i) a transmission information storing section (14) which associates line sound information indicating whether to emit a line sound that is a sound indicating a communication signal generated at the time of data transmission with a destination number specifying a destination of data and stores the line sound information and the destination number, (ii) a transmission control section (12) which controls data transmission to the destination on the basis of the destination number, (iii) a speaker section (sound generating section) (3) which emits the line sound, and (iv) a speaker control section (line sound control section) (13) which controls whether or not the speaker section (3) emits the line sound on the basis of the line sound information. With this, it is possible to change whether to emit the line sound in accordance with, for example, the destination.

### TECHNICAL FIELD

The present invention relates to a communication apparatus, such as a facsimile.

### BACKGROUND ART

Generally, most facsimile equipments having an autodial FAX transmission function have the so-called dual-access function to improve work efficiency. The dual-access function is such a function that, even while the facsimile equipment is carrying out a transmission operation and/or a reception operation, it is possible to carry out an operation, such as a reservation of transmission to a destination, without waiting for the termination of the transmission operation and/or the reception operation. Its one example is disclosed in Japanese Unexamined Patent Publication No. 8-46737 (Tokukaihei 8-46737, published on Feb. 16, 1996).

In the case of utilizing this dual-access function, a transmission document read by a scanner is once stored in a memory. Then, when the foregoing transmission operation and/or reception operation are (is) terminated and the line is idle, the FAX number of the destination is dialed automatically. In the case of monitoring a line sound when the dual-access function is working as above, it is impossible to find out which destination the facsimile apparatus is communicating with, but a dial sound and a communication sound keep on ringing. Therefore, most of this type of facsimile equipments do not monitor the line sound in a state of an autodial transmission (that is, a dial tone, the dial sound, CNG, CED, etc. on the line are not outputted through a speaker).

Meanwhile, some equipments having poor dual-access function, such as a household facsimile equipment, monitor the line sounds of all the transmissions. Especially, most facsimile equipments having an on-hook dialing function monitor the line sounds.

As described above, there are two types of existing facsimile equipments, one monitoring the line sound and another not monitoring the line sound. This is because the function of monitoring the line sound has good points and bad points.

For example, in cases where an operator who is familiar with the facsimile apparatus so that he/she does not have the wrong FAX number uses the facsimile apparatus consecutively, the line sound is just an unwanted sound. Meanwhile, in cases where (i) a document is transmitted to an important destination, (ii) an important document is transmitted, or (iii) an operator who is not familiar with a FAX operation carries out a FAX transmission, there may be such a situation that, even in the case of an autodial memory transmission, the operator wants to hear a dial signal and a FAX signal by monitoring the line sound for confirmation.

Here, there is a demand for a facsimile equipment which allows an operator to monitor the line sound only when the operator wishes to monitor it. However, currently, there exists no apparatus having such a function.

The present invention was made to solve the above problems, and an object of the present invention is to realize a communication apparatus which allows a user to select whether or not the line sound is emitted.

### DISCLOSURE OF INVENTION

To solve the above problems, a communication apparatus of the present invention is a communication apparatus which transmits data outward through a line, and includes: a sound generating section which emits a line sound that is a sound indicating a communication signal generated at the time of data transmission; and a line sound control section which controls whether or not the sound generating section emits the line sound.

The communication apparatus of the present invention is an apparatus, such as a facsimile, which transmits and receives data to and from an external apparatus through a line. To allow a user to confirm that the communication apparatus is in communication with the destination, the communication apparatus includes the sound generating section which emits the line sound that is the sound indicating the communication signal generated at the time of data transmission. Examples of the line sound are tones of dialing and facsimile. Then, the communication apparatus of the present invention controls whether or not the line sound control section emits the line sound.

Therefore, according to the above configuration, it is possible to accordingly change whether or not the sound generating section emits the line sound. Thus, it is possible to avoid a drawback of a communication apparatus which always emits the line sound, that is, a problem of the line sound being an unwanted sound. Moreover, it is also possible to avoid a drawback of a communication apparatus which does not emit the line sound at all, that is, a problem of not being able to confirm, by a sound, that the data transmission to an important destination is being carried out.

That is, for example, in cases where the data transmission is carried out by the operator who is accustomed to an operation of transmitting data using this communication apparatus, it is possible not to emit the offensive line sound by controlling the line sound control section so that the line sound is not emitted. Meanwhile, in cases where (i) important data is transmitted, or (ii) the data transmission is carried out by the operator who is not accustomed to the operation of this communication apparatus, the line sound is emitted at the time of data transmission by controlling the line sound control section so that the line sound is emitted. Thus, it is possible to confirm an execution of the transmission.

Moreover, a method for controlling a communication apparatus of the present invention is a control method of a communication apparatus which transmits data outward through a line, and the method includes the steps of: selecting whether to emit a line sound that is a sound indicating a communication signal generated at the time of data transmission; and controlling, based on a result of the above selection, whether to emit the line sound at the time of data transmission.

According to the control method of the present invention, it is possible to accordingly change whether to emit the line sound at the time of data transmission. Thus, it is possible to avoid a drawback of a communication apparatus which always emits the line sound, that is, a problem of the line sound being an unwanted sound. Moreover, it is also possible to avoid a drawback of a communication apparatus which does not emit the line sound at all, that is, a problem of not being able to confirm, by a sound, that the data transmission to an important destination is being carried out.

Note that the communication apparatus may be realized by a computer. In this case, a computer-readable recording medium recording a program causing a computer to function as the above respective sections of the communication apparatus is also encompassed in the scope of the present invention.

That is, a program for controlling a communication apparatus of the present invention causes a computer to realize functions of any one of the above communication apparatuses. Moreover, a recording medium of the present invention is a computer-readable recording medium recording the above program.

Additional objects, features, and strengths of the present invention will be made clear by the description below. Further, the advantages of the present invention will be evident from the following explanation in reference to the drawings.

### BRIEF DESCRIPTION OF DRAWINGS

FIG. 1 is a functional block diagram showing a configuration of a multifunction device of one embodiment of the present invention.

FIG. 2 is a perspective view schematically showing an appearance of the multifunction device shown in FIG. 1.

FIG. 3 is a plan view showing an operating section included in the multifunction device shown in FIG. 1.

FIG. 4 is a schematic diagram showing one example of a data list stored in a transmission information storing section of the multifunction device shown in FIG. 1.

FIG. 5 is a schematic diagram showing one example of a destination data list stored in the multifunction device shown in FIG. 1.

FIG. 6 is a schematic diagram showing (i) a method for registering an abbreviated number and a group number and (ii) a method for setting ON/OFF of a line sound monitoring, in the operating section of the multifunction device shown in FIG. 1.

FIG. 7 is a flow chart showing a flow of a processing of a FAX transmission reservation in the multifunction device shown in FIG. 1.

FIG. 8 is a flow chart showing a flow of a FAX transmission processing in the multifunction device shown in FIG. 1.

FIG. 9 is a flow chart showing a flow of a line sound output control in the multifunction device shown in FIG. 1.

FIG. 10(a) is a schematic diagram showing one example of a screen image displayed, when printing, on a display of a PC connected to the multifunction device shown in FIG. 1.

FIG. 10(b) is a schematic diagram showing one example of a screen image displayed, when carrying out a FAX transmission, on a display of a PC connected to the multifunction device shown in FIG. 1.

### BEST MODE FOR CARRYING OUT THE INVENTION

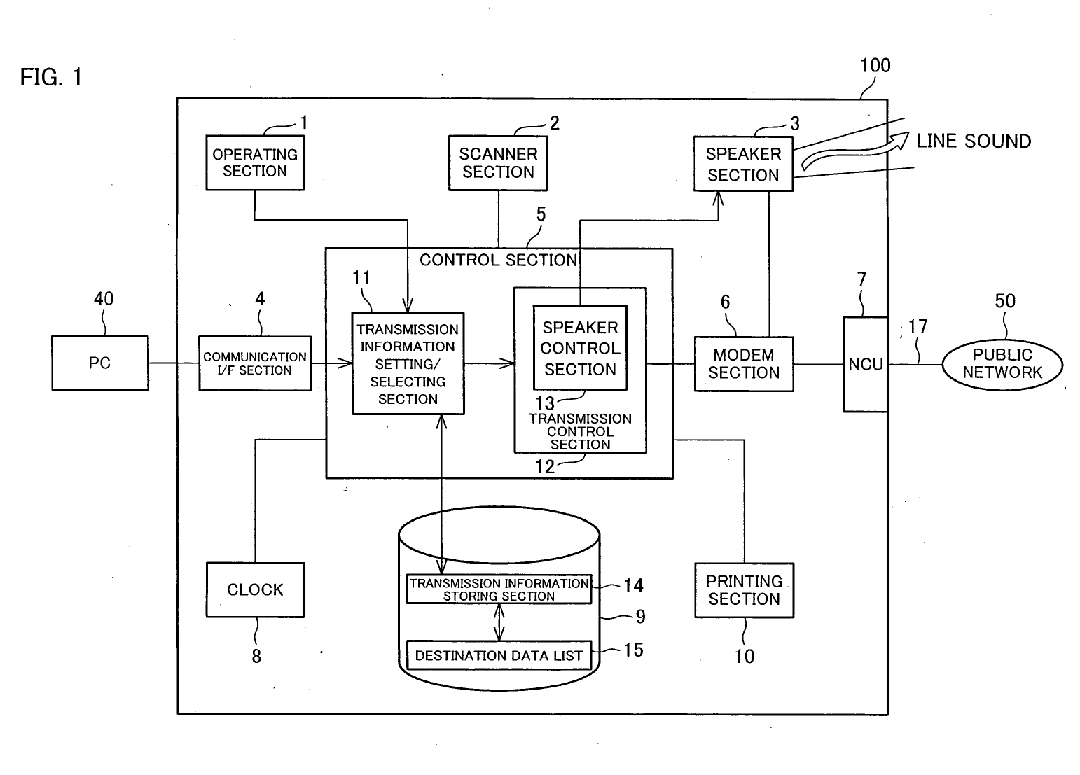

The following will explain one embodiment of the present invention on the basis of FIGS. 1 to 10.

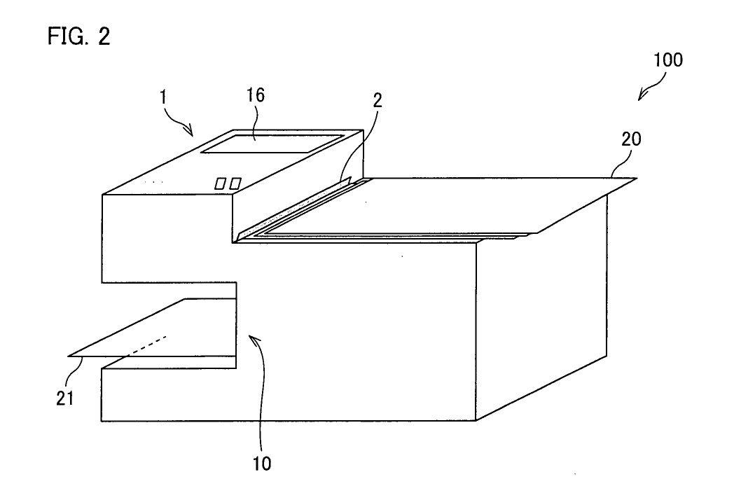

The present embodiment is explained using, as one example of a communication apparatus of the present invention, a multifunction device 100 having functions of a facsimile, a printer, a copier, etc. FIG. 1 is a functional block diagram showing a configuration of this multifunction device 100, and FIG. 2 is a perspective view showing an appearance of this multifunction device 100.

As shown in FIG. 1, the multifunction device 100 includes an operating section (acquiring section) 1, a scanner section 2, a speaker section (sound generating section) 3, a communication I/F section (acquiring section) 4, a control section 5, a modem section 6, a NCU section 7, a clock section 8, a storing section 9, and a printing section 10.

The operating section 1 allows an operator to carry out a key input to reserve or execute various settings or communication processings. The scanner section 2 reads image data of a document for FAX transmission or a document to be copied. The speaker section 3 makes, via a speaker, a sound, such as the line sound or a buzzer sound generated at the time of data transmission. The communication I/F section 4 receives data from a PC. The control section 5 controls operations of the entire apparatus, and it gives commands to respective sections and transmits/receives commands between controls. The modem section 6 controls transmission and reception of a FAX. The NCU section 7 controls a line control circuit (NCU). The clock section 8 is a real-time clock for time management. The storing section 9 manages and stores various setting data and image data. The printing section 10 is output means for printing and recording data.

The communication I/F section 4 is connected, via a USB or the like, to a PC 40 having a driver which can interface an apparatus having a facsimile function, such as PC-FAX. Moreover, the NCU section 7 is connected to a public network 50 via a line 17 for FAX transmission and FAX reception.

The control section 5 includes the operating section 1, a transmission information setting/selecting section (transmission information setting section) 11, and a transmission control section 12. Based on an instruction, which is supplied from the external PC 40, of carrying out the FAX transmission, the transmission information setting/selecting section (transmission information setting section) 11 selects and sets transmission information containing a destination, ON/OFF of the line sound monitoring, data of a document to be transmitted, etc. Moreover, based on the transmission information set in the transmission information setting/selecting section 11, the transmission control section 12 controls data transmission by the FAX. Further, the transmission control section 12 includes a speaker control section (line sound control section) 13 which controls whether or not the speaker section 3 outputs the line sound, such as a dial tone, dial sound, CNG, CED, etc. on the line.

Moreover, the storing section 9 includes a transmission information storing section 14 and a destination data list (destination information list) 15. The transmission information storing section 14 stores the transmission information set in the transmission information setting/selecting section 11. The destination data list (destination information list) 15 is a list containing names of destinations and FAX numbers corresponding to abbreviated numbers (identification numbers) and group numbers.

Moreover, as shown in FIG. 2, the operating section 1 is provided at an upper surface of the multifunction device 100. Then, the operating section 1 includes a display section 16 which shows a state(s) of transmission and a key(s) inputted. Moreover, the scanner section 2 is provided under the operating section 1. Then, the content of a document 20 for FAX transmission or the content of the document 20 to be copied passes through this scanner section 2 so as to be read. Moreover, the printing section 10 is provided under the scanner section 2. The image data read by the scanner section 2 is printed on a sheet which passes through this printing section 10, and this sheet is outputted as a printed matter 21.

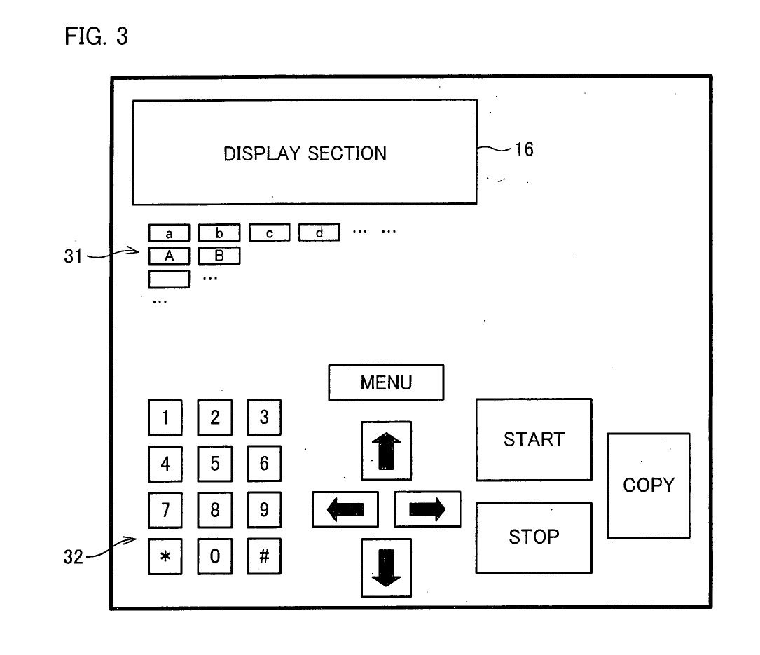

FIG. 3 is a plan view showing the configuration of the operating section 1 more specifically. As shown in FIG. 3, the display section 16 including a liquid crystal display apparatus and/or the like is provided on the upper left of the operating section 1. Moreover, provided under the operating section 1 are abbreviated keys 31 in which registered are (i) the abbreviated number(s) which enables a one-touch FAX transmission to the registered destination and (ii) the group number(s) which realizes a transmission to a plurality of FAX destinations. Provided under the abbreviated keys 31 is a numeric keypad 32 by which the FAX number of the destination can be inputted when carrying out the FAX transmission or the number of copies can be inputted when copying documents. Provided on the right of the numeric keypad 32 are a “MENU” key and arrow keys, and provided on the right of these keys are a “START” key and a “STOP” key. Then, a “COPY” key is provided on the far right.

When the operator uses the multifunction device 100, he/she first presses the MENU key so as to select which function of the multifunction device 100 to use. Then, using the arrow keys, the numeric keypad, respective operation keys, etc., the operator carries out settings of various conditions in the case of using each function (in the case of using a copier function for example, settings of the number of copies, the print density, the print magnification, etc.).

The following will explain a processing when carrying out the FAX transmission using the multifunction device 100. As described above, the multifunction device 100 has functions of a facsimile, a printer, a copier, etc. As a characteristic function, the multifunction device 100 has a function of being able to select, depending on the set transmission information, whether to emit the line sound especially at the time of FAX transmission.

Note that the multifunction device 100 of the present embodiment has the same functions as a conventionally known multifunction device except for the function of FAX transmission. Therefore, explanations of the functions of the multifunction device 100 other than the explanation of the function of FAX transmission are omitted here.

When carrying out, using the multifunction device 100, the FAX transmission of data of a document read by the scanner section 2, the document for data transmission is first placed on a document table provided near the scanner section 2. Then, various conditions regarding this transmission are inputted in the operating section 1. Examples of the various conditions are (i) the FAX number of the destination (the abbreviated number or the group number when this destination is registered as the abbreviated number or as the group number), (ii) information (line sound information) regarding ON/OFF setting of the line sound monitoring.

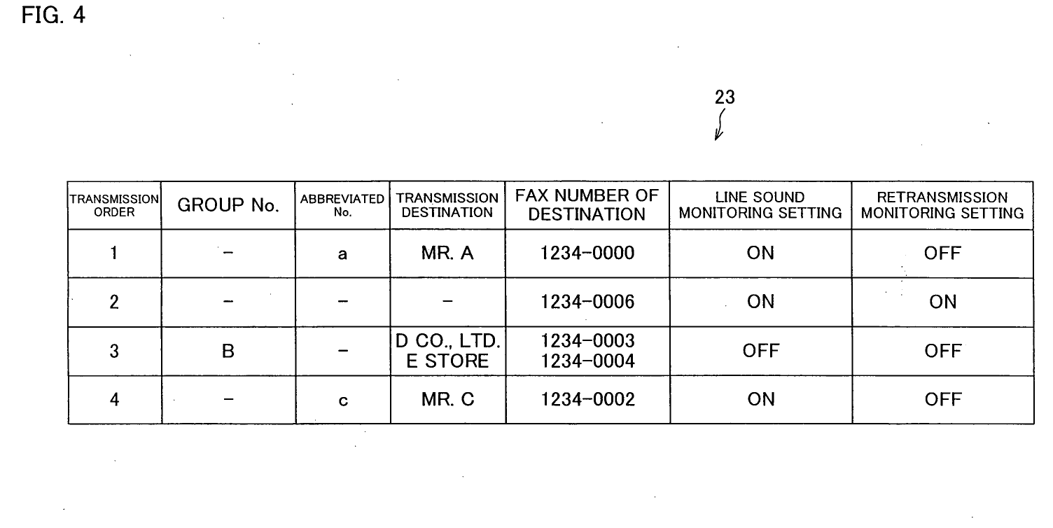

The information inputted in the operating section 1 is transmitted to the transmission information setting/selecting section 11 in the control section 5. The transmission information setting/selecting section 11 determines a transmission order in accordance with the order of inputting, arranges the input transmission information in accordance with the transmission order, and stores the transmission information in the form of a data list in the transmission information storing section 14 in the storing section 9. FIG. 4 shows one example of the data list stored in the transmission information storing section 14.

As shown in FIG. 4, a data list 23 stored in the transmission information storing section 14 includes information, such as (i) the transmission order, (ii) the group number (group No.), (iii) the abbreviated number (abbreviated No.), (iv) the transmission destination, (v) the FAX number of the destination, (vi) a line sound monitoring setting and (vii) a retransmission monitoring setting. When the group number is inputted, the corresponding group number is written in the “GROUP No.” field, the registered name of the transmission destination is written in the “TRANSMISSION DESTINATION” field, and the registered FAX number of the destination is written in the “FAX NUMBER OF DESTINATION” field. Moreover, when the abbreviated number is inputted, the corresponding abbreviated number is written in the “ABBREVIATED No.” field, the registered name of the transmission destination is written in the “TRANSMISSION DESTINATION” field, and the registered FAX number of the destination is written in the “FAX NUMBER OF DESTINATION” field. Moreover, when the FAX number of the destination is inputted in the operating section 1, nothing is written in the “GROUP No.” field, the “ABBREVIATED No.” field, or the “TRANSMISSION DESTINATION” field, but only the inputted FAX number of the destination is written.

When the FAX number of the destination is inputted using the numeric keypad 32 in the operating section 1, information regarding whether or not the “LINE SOUND MONITORING SETTING” is turned ON and information regarding whether or not the “RETRANSMISSION MONITORING SETTING” is turned ON are also inputted.

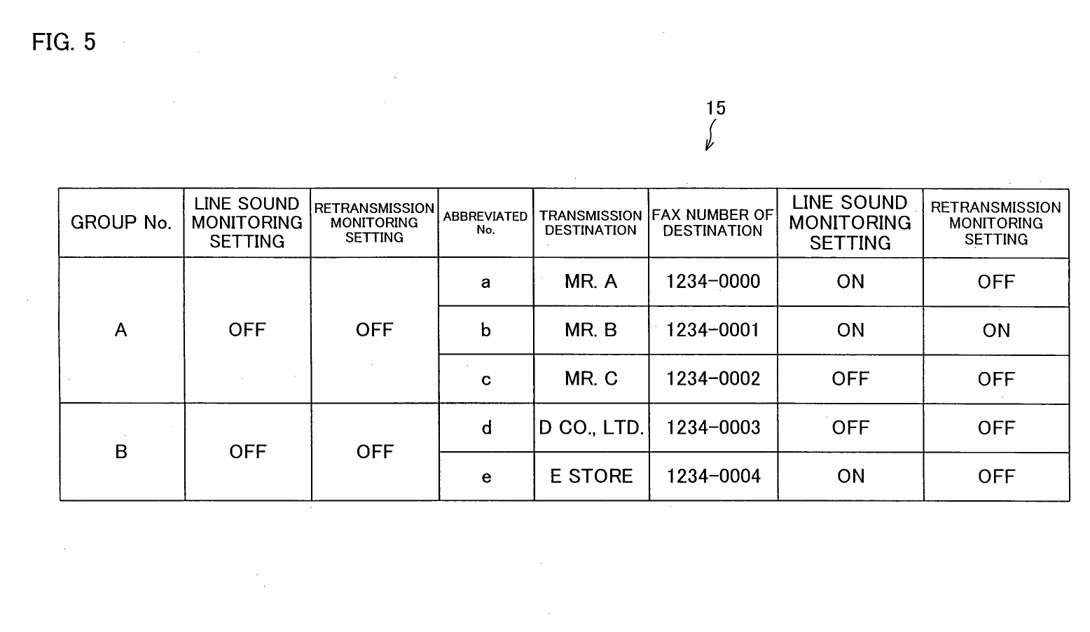

When the destination is inputted in the operating section 1 using the group number or the abbreviated number, the corresponding transmission information is selected in the transmission information setting/selecting section 11 from the destination data list 15 stored in the storing section 9. Then, the selected transmission information is additionally registered in the data list 23 of the transmission information storing section 14 so as to be the last of the transmission order. FIG. 5 shows one example of the destination data list 15.

As shown in FIG. 5, the destination data list 15 records various transmission information corresponding to the registered group number (GROUP No.) and the abbreviated number (ABBREVIATED No.). The various transmission information include information, such as the transmission destination, the FAX number of the destination, the line sound monitoring setting, and the retransmission monitoring setting. Note that each of the line sound monitoring setting and the retransmission monitoring setting is set for each abbreviated number and each group number.

Here, the “LINE SOUND MONITORING SETTING” in each of the data lists shown in FIGS. 4 and 5 being ON is such a setting that the line sound is outputted at the time of FAX transmission. Moreover, the “LINE SOUND MONITORING SETTING” being OFF is such a setting that the line sound is not outputted at the time of FAX transmission. Moreover, the “RETRANSMISSION MONITORING SETTING” is a setting regarding whether or not the line sound is emitted at the time of retransmission carried out when the first transmission is not terminated successfully. Then, the “RETRANSMISSION MONITORING SETTING” being ON is such a setting that the line sound is outputted at the time of FAX retransmission. Moreover, the “RETRANSMISSION MONITORING SETTING” being OFF is such a setting that the line sound is not outputted at the time of FAX retransmission. That is, each of the above “ON/OFF of the line sound monitoring setting” and the above “ON/OFF of the retransmission monitoring setting” is the line sound information regarding whether or not the line sound is emitted from the speaker section 3.

Note that the “RETRANSMISSION MONITORING SETTING” of the transmission information of the transmission order No. 4 shown in FIG. 4 is different from that of the transmission information registered in the destination data list 15 shown in FIG. 5. This is because, when inputting in the operating section 1, the operator has manually changed the setting of the transmission information registered in advance. Thus, the multifunction device 100 can control the FAX transmission in accordance with the transmission information stored in the destination data list 15, and in addition, it can also carry out the FAX transmission on the basis of the transmission information which is different from the transmission information stored in the destination data list 15 by manually changing the setting when inputting in the operating section 1.

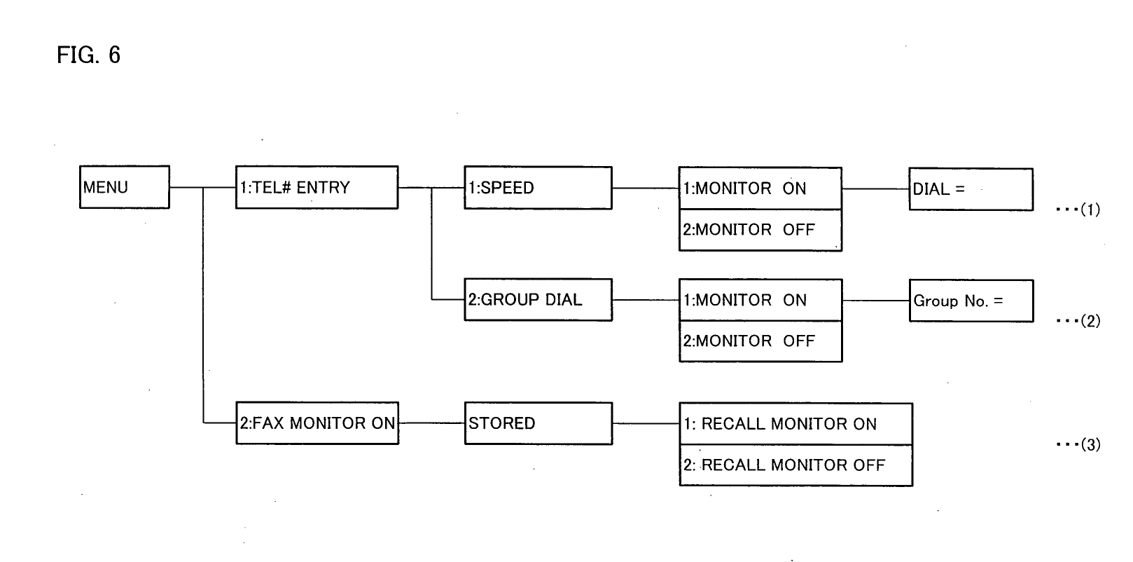

FIG. 6 schematically shows (i) one example of a method for setting the abbreviated number and the group number in the operating section 1 and (ii) one example of a method for setting ON/OFF of the line sound monitoring for only one communication for which the FAX number is inputted. FIG. 6, (1) shows a case of registering the abbreviated number and setting the line sound monitoring corresponding to this abbreviated number. Moreover, FIG. 6, (2) shows a case of registering the group number and setting the line sound monitoring corresponding to this group number. Further, FIG. 6, (3) shows a case of setting the line sound monitoring being ON for only one communication for which the FAX number is inputted, and setting ON/OFF of the retransmission monitoring.

There are various specific methods for carrying out these settings. For example, if the display section 16 is a touch-panel-type liquid crystal display apparatus, touch keys for setting various conditions shown in FIG. 6 are sequentially displayed on the display section 16. By directly pressing the touch keys with one's finger, it is possible to set various conditions.

As above, for the respective transmission information inputted sequentially, the transmission information setting/selecting section 11 creates the data list 23 (see FIG. 4) in which the corresponding line sound information and the corresponding FAX number of the destination are associated with each other, and stores the data list 23 in the transmission information storing section 14. Note that the transmission information setting/selecting section 11 also carries out a processing of associating the read image data and read image parameter of the document read at the time of input of the destination with the FAX number of the destination, and stores them as FAX management information in the transmission information storing section 14.

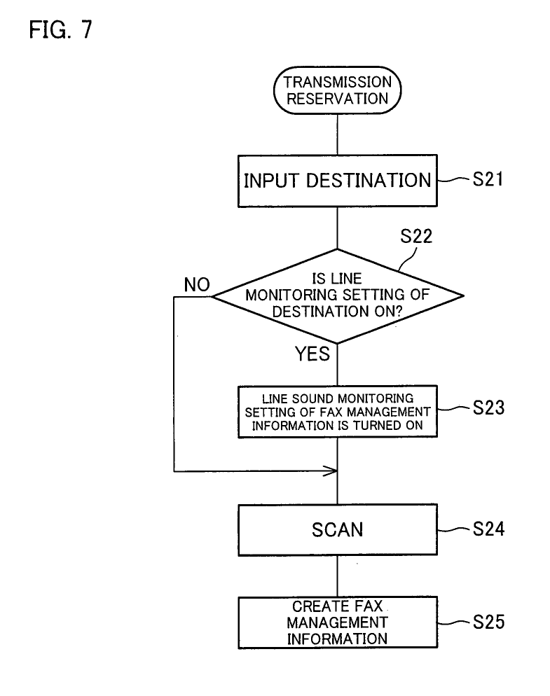

The following will explain a flow of a FAX transmission processing in the multifunction device 100 and a flow of a line sound output control in reference to the flow charts of FIGS. 7 to 9.

First, a processing of a FAX transmission reservation is explained in reference to the flow chart of FIG. 7. The operator first inputs the destination using the operating section 1 (Step S21). As described above, examples of a method for inputting the destination are (i) a method for directly specifying the FAX number of the destination using the numeric keypad 32 shown in FIG. 3, (ii) a method for using the FAX number registered in a one-touch dialing or a registered specifying number (dialing), and (iii) a method for specifying a number in which the FAX numbers are grouped. When the group number is specified, the information transmission is carried out sequentially with respect to a plurality of destinations registered in the group number. Here, when the FAX number of the destination is directly specified using the numeric keypad 32, the line sound information regarding whether or not the line sound is emitted at the time of the FAX transmission is also inputted.

When the input of the destination is determined, the inputted information is transmitted to the transmission information setting/selecting section 11. The transmission information setting/selecting section 11 determines whether or not the line sound monitoring is carried out at the time of the transmission to the inputted destination (Step S22). Here, when the inputted destination is the destination directly inputted using the numeric keypad, whether or not a one communication line monitoring setting (see FIG. 6, (3)) set in advance is ON is determined (Step S22). Then, when the line sound monitoring setting is ON (YES in Step S22), a line sound monitoring setting flag of the data list (see FIG. 4) in the transmission information storing section 14 which manages the transmission information is turned ON (Step S23).

Moreover, when the inputted destination is the destination specified by the one-touch dialing or the registered specifying number (abbreviated number), the line sound monitoring function can be set at the time of setting of the abbreviated number by the method shown in FIG. 6. Then, when the line sound monitoring setting is ON (YES in Step S22), the line sound monitoring setting flag of the data list (see FIG. 4) in the transmission information storing section 14 is turned ON (Step S23) as with the case of using the numeric keypad. The case of using the group number is the same as above, that is, when the line sound monitoring setting is ON at the time of registration of the group number (YES in Step S22), the line sound monitoring setting flag of the data list (see FIG. 4) in the transmission information storing section 14 is turned ON (Step S23).

When the line sound monitoring setting of the FAX management information is determined, the scanner section 2 reads the document 20 so as to create the read image data and the read image parameter (Step S24). Then, the image data and the image parameter are stored in the transmission information storing section 14 as the FAX management information. Thus, the FAX management information containing information, such as the FAX number of the destination, the read image data, the read image parameter, the line monitoring setting, and the like is created. Here, in the transmission information storing section 14, the data list 23 shown in FIG. 4 is updated so that the transmission information corresponding to the stored image data becomes the last of the transmission order (Step S25).

Note that when the destination is directly specified using the numeric keypad 32, the one communication line monitoring setting inputted in the display section 16 and shown in FIG. 6 is switched from ON to OFF. This is because since this setting is only for one communication, it is necessary to clear it at the time that the autodial FAX transmission is determined. The timing for clearing the setting may be when the key input is determined or when the reading is terminated successfully.

Meanwhile, when the line sound monitoring setting is OFF (NO in Step S22), the line sound monitoring setting flag of the data list (see FIG. 4) in the transmission information storing section 14 is not turned ON (that is, it remains in an OFF state), the scanner section 2 reads the document (Step S24).

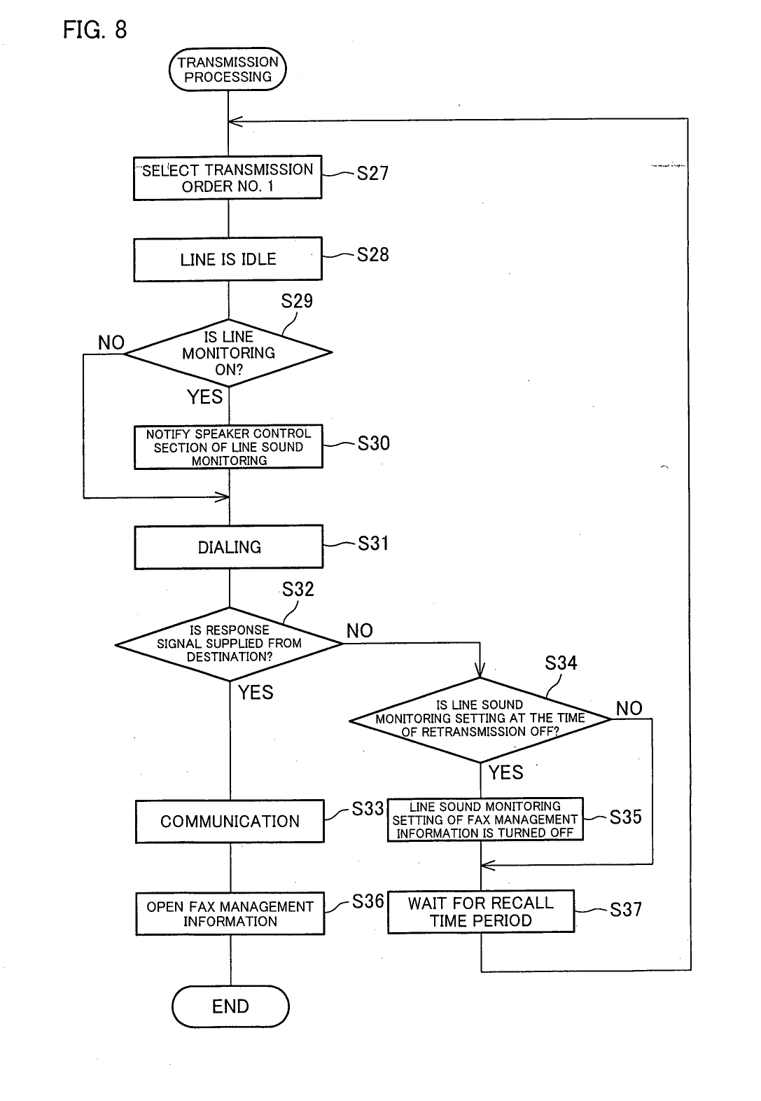

Next, referring to FIG. 8, the following will explain the flow of a processing in the case of carrying out the FAX transmission processing of the FAX management information prepared by the above-described FAX transmission reservation processing.

First, when there exists the FAX management information to be transmitted, the transmission information setting/selecting section 11 selects the transmission information corresponding to the transmission order No. 1 in the data list shown in FIG. 4 (Step S27). Then, the NCU section 7 confirms whether or not the line is idle (Step S28). Here, when the line is idle, the transmission control section 12 confirms the line sound monitoring setting flag of the FAX management information, set at the time of the transmission reservation, on the basis of the transmission information selected in the transmission information setting/selecting section 11 (Step S29).

Here, when the line monitoring setting is ON (YES in Step S29), a notification indicating that it is necessary to monitor the line sound at the time of acquisition of the line is supplied to the speaker control section 13 (Step S30). Meanwhile, when the line monitoring setting is OFF (NO in Step S29), the above notification is not supplied.

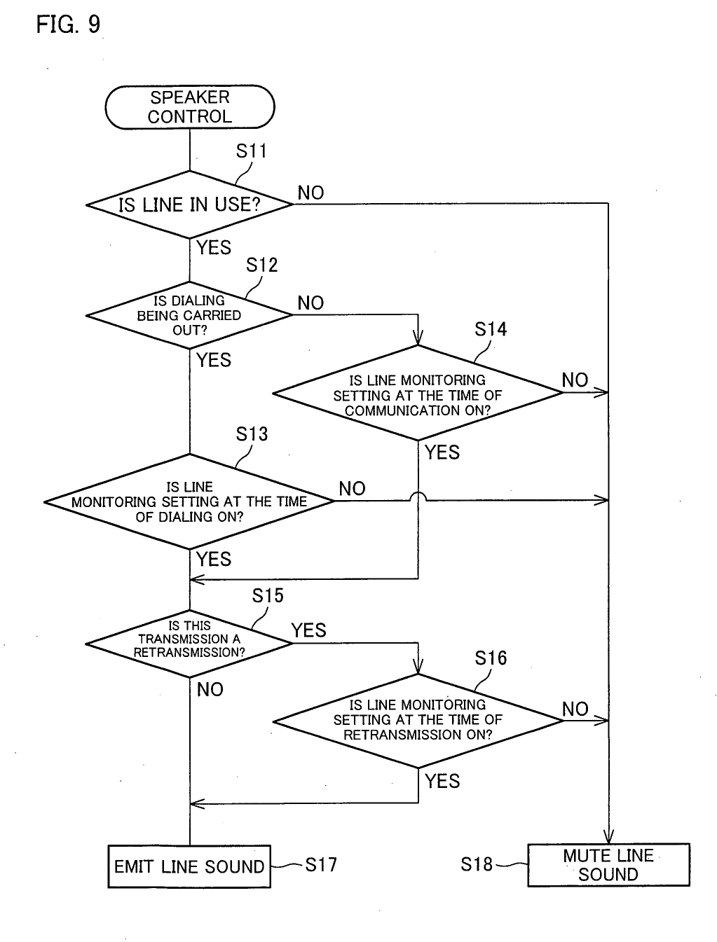

Then, the line is acquired, and the dialing is carried out after a certain time period (Step S31). Then, when the notification of the line sound monitoring is supplied, the speaker control section 13 causes the speaker section 3 to output the dial tone sound or the dial sound on the line in accordance with the flow chart (FIG. 9) of the processing of the speaker control section 13 (will be described later).

Then, when a response signal (CED, etc.) is received from the destination (YES in Step S32), communication start-up is carried out, and then the FAX transmission is carried out (Step S33). Note that the multifunction device 100 of the present embodiment can be set so that the line sound is outputted from the speaker section 3 during the communication. This will be explained in detail in an explanation using the flow chart (shown in FIG. 9) of the processing of the speaker control section 13.

When the communication is terminated, the line connection is cut, and the FAX management information is open. Then, the transmission information of the transmission order No. 1 in the data list stored in the transmission information storing section 14 is deleted, and the transmission order of the transmission information of each of the transmission order No. 2 and later is advanced by one (Step S36).

Meanwhile, when no response signal is supplied from the destination and the dialing is terminated since the line is busy (NO in Step S32), whether or not the line sound monitoring setting at the time of retransmission is OFF is confirmed (Step S34). Here, only when the line sound monitoring setting at the time of retransmission is OFF (YES in Step S34), the line sound monitoring setting flag is turned OFF (Step S35). In the case of carrying out the retransmission, the processing starts from the beginning (Step S27) of the transmission processing flow chart of FIG. 8 after a set recalling waiting time period (Step S37).

Next, referring to the flow chart shown in FIG. 9, the following will explain a method for controlling the line sound emitted from the speaker section 3 in the speaker control section 13.

The speaker control section 13 confirms whether or not the line is in use (Step S11). Here, when the line is not in use (NO in Step S11), the speaker control section 13 controls the speaker section 3 so that the speaker section 3 does not emit the line sound (Step S18).

When the line is in use (YES in Step S11), whether or not the dialing is being carried out is confirmed (Step S12). Here, when the dialing is being carried out (YES in Step S12), the line sound monitoring setting flag of the FAX management information is confirmed (Step S13). Here, when the line sound monitoring setting flag is not ON (NO in Step S13), the speaker section 3 is controlled so as not to emit the line sound (Step S18).

Meanwhile, when the line sound monitoring setting flag is ON (YES in Step S13), whether or not this transmission is a retransmission is confirmed (Step S15). Here, when this transmission is not the retransmission (NO in Step S15), the speaker section 3 is controlled so as to emit the line sound (Step S17). Meanwhile, when this transmission is the retransmission (YES in Step S15), whether or nor the line sound monitoring setting at the time of retransmission is ON is confirmed (Step S16).

Here, when the line sound monitoring setting at the time of retransmission is ON (YES in Step S16), the speaker section 3 is controlled so as to emit the line sound (Step S17). Meanwhile, when the line sound monitoring setting at the time of retransmission is not ON (NO in Step S16), the speaker section 3 is controlled so as not to emit the line sound (Step S18).

Note that in the above processing, whether or not the dialing is being carried out is confirmed. When the dialing is not being carried out (NO in Step S12), whether or not the line monitoring setting at the time of communication is ON is confirmed (Step S14). Here, when the line monitoring setting at the time of communication is not ON (NO in Step S14), the speaker section 3 is controlled so as not to emit the line sound (Step S 18). Meanwhile, when the line monitoring setting at the time of communication is ON (YES in Step S14), whether or not this transmission is a retransmission is confirmed (Step S15). Then, the same steps as the above Step S15 and later are carried out.

In the FAX transmission by the autodialing, by carrying out the above-described processing, it is possible to confirm, only when necessary, the execution of the FAX transmission, like on-hook dialing.

Moreover, also at the time of retransmission automatically carried out when the first transmission is not terminated successfully since the line is busy or time is up, the multifunction device 100 of the present embodiment can set, according to need, whether to monitor the line sound. Since, in the case of a recall, etc., the time has elapsed since the transmission reservation, the operator may not be there. Therefore, under normal conditions, it is preferable to set the line sound so that the line sound is not monitored at the time of the recall.

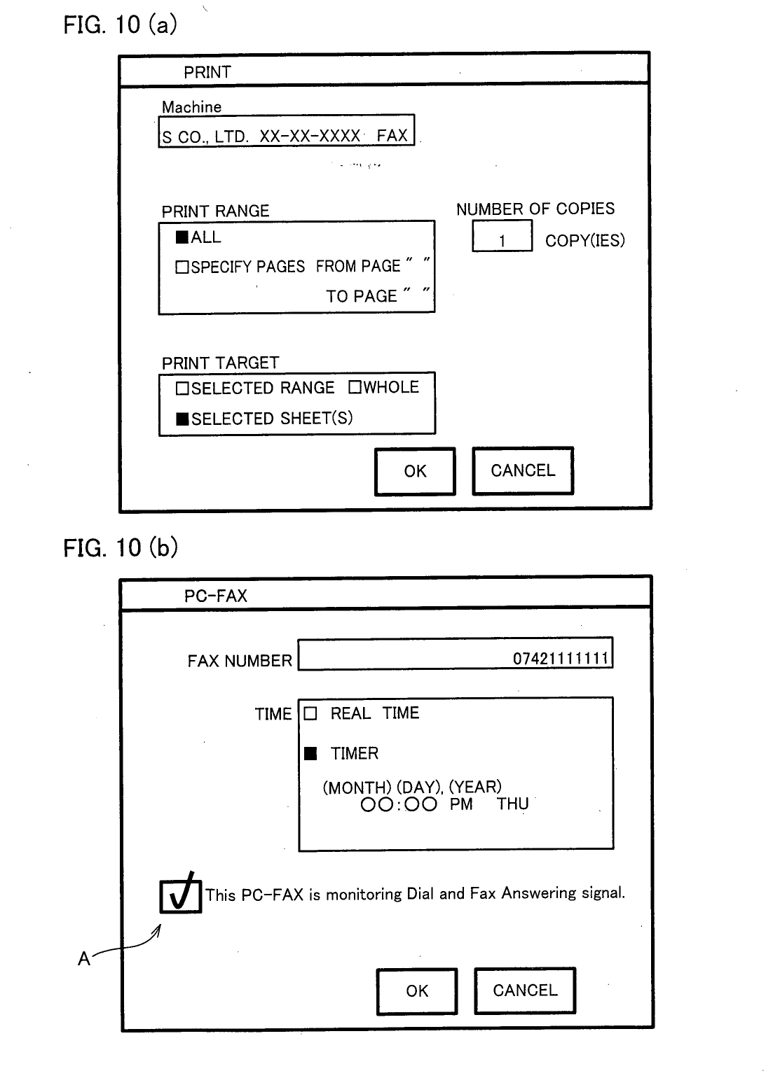

Moreover, the multifunction device 100 of the present embodiment is connected to the PC 40 via the communication I/F section 4. Then, the image data created in the PC 40 may be FAX-transmitted or printed using the multifunction device 100. When the image data created in the PC 40 is FAX-transmitted or printed using the multifunction device 100, an image shown in, for example, FIG. 10(a) or 10(b) is displayed on the display of the PC 40. Note that FIG. 10(a) is an example of a screen image displayed when printing, and FIG. 10(b) is one example of a screen image displayed when carrying out the FAX transmission.

Then, since the transmission information setting/selecting section 11 in the multifunction device 100 is connected to the PC 40 via the communication I/F section 4, the communication I/F section 4 receives, when carrying out the FAX transmission, the FAX number and the line sound information, or the abbreviated number and the like inputted in the PC 40, and transmits them to the transmission information setting/selecting section 11. The transmission information setting/selecting section 11 carries out setting of the FAX transmission information on the basis of the received information. Then, the line monitoring setting is realized by, for example, providing a check box indicated by an arrow A in a “PC-FAX” screen shown in FIG. 10(b).

Here, when a box indicating that the line sound is monitored is marked, the line monitor flag of the FAX management information is turned ON. Meanwhile, when the box indicating that the line sound is monitored is not marked, the line monitor flag of the FAX management information is turned OFF. Thus, the processings shown in the flow charts of FIGS. 7 and 8 are carried out, and it is possible to control whether or not the speaker control section 13 causes the speaker section 3 to output the line sound at the time of the FAX transmission.

Therefore, even at the time of autodial transmission by a FAX reservation from the PC 40, it is possible to set whether to monitor the line sound according to need. Note that it is possible to realize such an arrangement that the line sound monitoring at the time of PC-FAX can be set in the MENU (see FIG. 6) in the operating section 1 of the multifunction device 100.

The present embodiment has explained, as one example of the communication apparatus of the present invention, the multifunction device having the facsimile function, however the present invention is not limited to this, and is applicable to any communication apparatus which transmits data using a line. Examples of the communication apparatus of the present invention are, in addition to the above-described multifunction device, an apparatus having only the facsimile function, a telephone with FAX, and a MFP (Multi Function Peripheral) with FAX.

The present invention is not limited to the embodiments above, but may be altered within the scope of the claims. An embodiment based upon a proper combination of technical means disclosed in different embodiments is encompassed in the technical scope of the present invention.

Note that respective sections and respective processing steps of the communication apparatus of the above embodiment can be realized by causing computing means (such as CPU) to execute a program stored in memory means (such as ROM (Read Only Memory) or RAM) and control input means (such as a keyboard), output means (such as a display), or communicating means (such as an interface circuit). Therefore, only by causing a computer having these means to read out a recording medium recording the above program and execute the program, it is possible to realize various functions and processings of the communication apparatus of the present embodiment. Moreover, by recording the above program in a removable recording medium, it is possible to realize the above functions and processings on any computer.

The recording medium may be a memory for process steps on a microcomputer. For example, the recording medium may be something like a ROM. Alternatively, the program medium may be such that a program reader device (not shown) as an external memory device may be provided in which a recording medium is inserted for reading.

In addition, in any case, the stored program is preferably executable on access by a microprocessor. Further, it is preferred if the program is retrieved, and the retrieved program is downloaded to a program storage area in a microcomputer to execute the program. The downloaded program is stored in a main body of the communication apparatus.

In addition, the program medium may be a storage medium constructed separably from a main body. The medium may be tape based, such as a magnetic tape or cassette tape; disc based, such as a flexible disc or hard disk including a magnetic disc and CD/MO/MD/DVD; card based, such as an IC card (including a memory card); or a semiconductor memory, such as a mask ROM, EPROM (Erasable Programmable Read Only Memory), EEPROM (Electrically Erasable Programmable Read Only Memory), and a flash ROM. All these types of media hold the program in a fixed manner.

In contrast, if the system is arranged to connect to the Internet or another communication network, the medium is preferably a storage medium which holds the program in a flowing manner so that the program can be downloaded over the communication network.

Further, if the program is downloaded over a communication network in this manner, it is preferred if the download program is either stored in a main body device in advance or installed from another storage medium.

As above, in the communication apparatus of the present invention, the line sound control section controls whether or not the sound generating section emits the line sound, on the basis of information in which whether or not the sound generating section emits the line sound at the time of transmission is being determined for each case.

According to the above configuration, the line sound control section can select, for each case, whether to emit the line sound. Note that the above “information in which whether or not the sound generating section emits the line sound at the time of transmission is being determined for each case” is information in which whether or not the line sound is emitted is determined for each case in accordance with conditions, such as the transmission destination, a transmission time, a person who carries out a transmission operation, and data to be transmitted.

In the communication apparatus of the present invention, the line sound control section controls whether or not the sound generating section emits the line sound, on the basis of information in which information used for transmission control is associated with line sound information indicating whether or not the sound generating section emits the line sound at the time of transmission.

According to the above configuration, the line sound control section can select whether to emit the line sound in accordance with the stored information used for transmission control. Note that examples of the above “information used for transmission control (sometimes referred to as transmission information)” are information specifying the destination and information regarding the number of transmissions reserved in, for example, a facsimile having the autodial transmission function. For example, when the information regarding the number of transmissions reserved is adopted as the information used for transmission control, it may be possible to store the line sound information indicating that the line sound is not emitted if the number of transmissions reserved is 3 or more. Moreover, it may be possible to store the line sound information indicating that the line sound is emitted if the number of transmissions reserved is 1 or 2.

In addition to the above configuration, the communication apparatus of the present invention further includes a list of information in which a destination number specifying a destination of data is associated with line sound information indicating whether or not the sound generating section emits the line sound at the time of transmission, and the line sound control section controls, at the time of data transmission to the destination number, whether or not the sound generating section emits the line sound, on the basis of the line sound information associated with the destination number.

According to the above configuration, by associating the line sound information with the destination number and storing them, it is possible to change whether to emit the line sound depending on the destination. Therefore, it is possible to accordingly select, for each destination, whether to emit the line sound.

Moreover, the transmission information storing section stores a number for identification and the line sound information which are associated with each other, and the destination number is also associated with the number for identification. At the time of transmission to a specific destination number, the line sound information identical with the number associated with this destination number is selected from the transmission information storing section, and then the line sound control section carries out control.

In addition to the above configuration, the communication apparatus of the present invention further includes: a transmission information storing section which associates line sound information indicating whether or not the sound generating section emits the line sound at the time of transmission with a destination number specifying a destination of data, so as to store the line sound information and the destination number; and a transmission control section which controls data transmission to the destination on the basis of the destination number, and the line sound control section controls, at the time of transmission to the destination number, whether or not the sound generating section emits the line sound, on the basis of the line sound information associated with the destination number.

According to the above configuration, by associating the line sound information with the destination number and storing them, it is possible to change whether to emit the line sound depending on the destination. Therefore, it is possible to accordingly select, for each destination, whether to emit the line sound. Note that the transmission information storing section is, for example, a section which temporarily stores the line sound information and destination number inputted from an operating panel or the like.

The communication apparatus further includes: an acquiring section which acquires the line sound information and the destination number; and a transmission information setting section which associates the line sound information, acquired by the acquiring section, with the destination number, so as to store the line sound information and the destination number in the transmission information storing section.

According to the above configuration, each time the transmission is set, it is possible to set the line sound information indicating whether or not the line sound is emitted. Therefore, it is possible to accordingly select whether to emit the line sound depending on a situation at the time of transmission. The acquiring section externally obtains information regarding whether to emit the line sound and information specifying the destination, and specific examples of the acquiring section are the operating panel (operating section) and a communication interface (communication I/F section).

If the acquiring section is the operating panel, it is possible to obtain the line sound information and the destination number by inputting, by a user (which is called an operator in the embodiment), the destination number and the line sound information in accordance with purposes.

If the acquiring section is the communication interface, it is possible to obtain the destination number and the line sound information from an external apparatus, such as a PC.

The communication apparatus further includes a destination information list in which the destination number, the line sound information and an identification number are associated with each other, and the transmission information setting section stores, in the transmission information storing section on the basis of the destination information list, the destination number and the line sound information which correspond to the identification number selected by a user (which is called an operator in the embodiment).

According to the above configuration, the transmission information of the destination, the number of transmissions to which is large, is stored in advance in the destination information list. Thus, without inputting the destination number at the time of transmission, it is possible to set the transmission by a simple operation, that is, by selecting the identification number using an operating input section. Then, for example, the destination information list may store the line sound information indicating that the line sound is emitted for an important destination. Meanwhile, the destination information list may store the line sound information indicating that the line sound is not emitted for an unimportant destination. Thus, it is possible to set the transmission without setting the line sound information for each transmission.

Moreover, the destination information list stores a plurality of the destination numbers as one group, and also stores the line sound information and a group number which are associated with each other for each group.

According to the above configuration, it is possible to set the transmission information, including the line sound information, per group in which a plurality of destinations are grouped.

Moreover, the line sound information contains information indicating whether to emit the line sound at the time of retransmission carried out when a first transmission is not terminated successfully.

This retransmission is a transmission automatically carried out when the first transmission is not successfully terminated since the line is busy or time is up, for example. According to the above configuration, it is possible to set, for each case, whether to emit the line sound at the time of retransmission, and it is possible to emit the line sound when necessary.

### INDUSTRIAL APPLICABILITY

The present invention is applicable to any communication apparatus which transmits data using a line, and can set, depending on the situation, whether or not the line sound is emitted.

1. A communication apparatus which transmits data outward through a line, comprising:
a sound generating section which emits a line sound that is a sound indicating a communication signal generated at the time of data transmission; and
a line sound control section which controls whether or not the sound generating section emits the line sound.

2. The communication apparatus as set forth in claim 1, wherein the line sound control section controls whether or not the sound generating section emits the line sound, on the basis of information in which whether or not the sound generating section emits the line sound at the time of transmission is being determined for each case.

3. The communication apparatus as set forth in claim 1, wherein the line sound control section controls whether or not the sound generating section emits the line sound, on the basis of information in which information used for transmission control is associated with line sound information indicating whether or not the sound generating section emits the line sound at the time of transmission.

4. The communication apparatus as set forth in claim 2, further comprising a list of information in which a destination number specifying a destination of data is associated with line sound information indicating whether or not the sound generating section emits the line sound at the time of transmission,
the line sound control section controlling, at the time of data transmission to the destination number, whether or not the sound generating section emits the line sound, on the basis of the line sound information associated with the destination number.

5. The communication apparatus as set forth in claim 3, further comprising a list of information in which a destination number specifying a destination of data is associated with line sound information indicating whether or not the sound generating section emits the line sound at the time of transmission,
the line sound control section controlling, at the time of data transmission to the destination number, whether or not the sound generating section emits the line sound, on the basis of the line sound information associated with the destination number.

6. The communication apparatus as set forth in claim 2, further comprising:
a transmission information storing section which associates line sound information indicating whether or not the sound generating section emits the line sound at the time of transmission with a destination number specifying a destination of data, so as to store the line sound information and the destination number; and
a transmission control section which controls data transmission to the destination on the basis of the destination number, the line sound control section controlling, at the time of transmission to the destination number, whether or not the sound generating section emits the line sound, on the basis of the line sound information associated with the destination number.

7. The communication apparatus as set forth in claim 3, further comprising:
a transmission information storing section which associates line sound information indicating whether or not the sound generating section emits the line sound at the time of transmission with a destination number specifying a destination of data, so as to store the line sound information and the destination number; and
a transmission control section which controls data transmission to the destination on the basis of the destination number,
the line sound control section controlling, at the time of transmission to the destination number, whether or not the sound generating section emits the line sound, on the basis of the line sound information associated with the destination number.

8. The communication apparatus as set forth in claim 6, further comprising:
an acquiring section which acquires the line sound information and the destination number; and
a transmission information setting section which associates the line sound information, acquired by the acquiring section, with the destination number, so as to store the line sound information and the destination number in the transmission information storing section.

9. The communication apparatus as set forth in claim 7, further comprising:
an acquiring section which acquires the line sound information and the destination number; and
a transmission information setting section which associates the line sound information, acquired by the acquiring section, with the destination number, so as to store the line sound information and the destination number in the transmission information storing section.

10. The communication apparatus as set forth in claim 8, further comprising a destination information list in which the destination number, the line sound information and an identification number are associated with each other,
the transmission information setting section storing, in the transmission information storing section on the basis of the destination information list, the destination number and the line sound information which correspond to the identification number selected by a user.

11. The communication apparatus as set forth in claim 9, further comprising a destination information list in which the destination number, the line sound information and the identification number are associated with each other,
the transmission information setting section storing, in the transmission information storing section on the basis of the destination information list, the destination number and the line sound information which correspond to the identification number selected by a user.

12. The communication apparatus as set forth in claim 10, wherein the destination information list stores a plurality of the destination numbers as one group, and also stores the line sound information and a group number which are associated with each other for each group.

13. The communication apparatus as set forth in claim 11, wherein the destination information list stores a plurality of the destination numbers as one group, and also stores the line sound information and a group number which are associated with each other for each group.

14. The communication apparatus as set forth in claim 4, wherein the line sound information contains information indicating whether to emit the line sound at the time of retransmission carried out when a first transmission is not terminated successfully.

15. The communication apparatus as set forth in claim 5, wherein the line sound information contains information indicating whether to emit the line sound at the time of retransmission carried out when a first transmission is not terminated successfully.

16. The communication apparatus as set forth in claim 6, wherein the line sound information contains information indicating whether to emit the line sound at the time of retransmission carried out when a first transmission is not terminated successfully.

17. The communication apparatus as set forth in claim 7, wherein the line sound information contains information indicating whether to emit the line sound at the time of retransmission carried out when a first transmission is not terminated successfully.

18. A method for controlling a communication apparatus which transmits data outward through a line, comprising the steps of:
selecting whether to emit a line sound that is a sound indicating a communication signal generated at the time of data transmission; and
controlling, based on a result of the above selection, whether to emit the line sound at the time of data transmission.

19. A control program causing a computer to realize functions of the communication apparatus as set forth in claims 1 to 17 claim 1.

20. A computer-readable recording medium recording the control program as set forth in claim 19.
